(19) United States
(12) Patent Application Publication
(10) Pub. No.: US 2019/0270153 A1
(43) Pub. Date: Sep. 5, 2019

(54) DUAL CATHODE TOOLING DEVICE FOR ELECTROEROSION

(71) Applicants: METALSA S.A. DE C.V., Apodaca (MX); LA CORPORACION MEXICANA DE INVESTIGACION EN MATERIALES, S.A. DE C.V., Saltillo (MX); CENTRO DE INGENIERIA Y DESARROLLO INDUSTRIAL, Santiago de Queretaro (MX)

(72) Inventors: Jesus Manuel Orona Hinojos, Saltillo (MX); Melvyn Alvarez Vera, Saltillo (MX); Pedro Perez Villanueva, Saltillo (MX); Rene Javier Hinojosa Garza, Escobedo (MX)

(21) Appl. No.: 15/911,805

(22) Filed: Mar. 5, 2018

(51) Int. Cl. B23H 5/02; B23H 1/06; B23H 1/08; B23H 3/06; B23H 7/26

(52) U.S. Cl. CPC B23H 5/02; B23H 1/06; B23H 7/26; B23H 3/06; B23H 1/08

(57) ABSTRACT

Electroerosion devices and methods for performing electroerosion machining are disclosed. The electroerosion devices may perform simultaneous electrical discharge machining and pulsed electrochemical machining (S-ED/PEC) through the use of at least two different types of electrodes and a quasi-dielectric working fluid.

### BACKGROUND

Electroerosion machining is a machining method that is generally used for machining hard metals or those that would be impossible to machine with other techniques using, e.g., lathes, drills, or the like. Thus, electroerosion machining can be used in trepanning or drilling operations for extremely hard steels and other hard, electrically conductive materials such as titanium, hastelloy, kovar, inconel, carbide, or the like. Different types of electroerosion machining include electrical discharge machining (ED) and electrochemical machining (EC).

Both EC and ED processes use electrical current under direct-current (DC) voltage to electrically power removal of the material from the workpiece. In EC, an electrically conductive liquid or electrolyte is circulated between the electrode(s) and the workpiece for permitting electrochemical dissolution of the workpiece material, as well as cooling and flushing the gap region therebetween. In ED, a nonconductive liquid or dielectric is circulated between the cathode and workpiece to permit electrical discharges in the gap therebetween for removing material from the workpiece.

### SUMMARY

Due to differences of the working fluid needed for EC and ED processes, conventional electroerosion devices are directed to performing one process of either EC or ED, but not both.

In one aspect, disclosed are electroerosion devices comprising an electrode assembly defining a central axis, the electrode assembly comprising a first electrode and a second electrode, the second electrode having a first open axial end to receive the first electrode and a second axial end that is at least partially closed by an end wall; a fluid supply containing a working fluid having a resistivity from about 0.01 MΩ·cm to about 1.5 MΩ·cm; a working apparatus configured to translate the electrode assembly relative to the workpiece; a power supply for electrically powering the electrode assembly; and a control system configured to control the power supply and the working apparatus.

In another aspect, disclosed are electroerosion machining methods, the methods comprising driving an electrode assembly towards a workpiece, wherein the electrode assembly comprises a first electrode and a second electrode, the second electrode having a first open axial end to receive the first electrode and a second axial end that is at least partially closed by an end wall; supplying or discharging an electrical current between the electrode assembly and the workpiece while feeding a working fluid from a fluid supply through a gap defined therebetween, wherein the working fluid has a resistivity from about 0.01 MΩ·cm to about 1.5 MΩ·cm and comprises NaBr, NaCl, KCl, Na₂SO₄, HCl or combinations thereof; and performing electrical discharge machining (ED), pulsed electrochemical machining (PEC), or a combination thereof.

### BRIEF DESCRIPTION OF THE DRAWINGS

FIG. 1 is a schematic of an electroerosion device, in accordance with one embodiment.

FIG. 2 is an illustration of an electrode assembly having a first electrode and a second electrode, wherein the first electrode is positioned within the second electrode and the second electrode lacks a pattern on its surface, in accordance with one embodiment.

FIG. 3 is an illustration of an electrode assembly having a first electrode and a second electrode, wherein the first electrode is positioned within the second electrode and the second electrode lacks a pattern on its surface, in accordance with one embodiment.

FIG. 4 is an illustration of an electrode assembly having a first electrode and a second electrode, wherein the first electrode is positioned within the second electrode and the second electrode has a patterned surface, in accordance with one embodiment.

FIG. 5A is an end view, in particular a top view, of a second electrode having a patterned surface in accordance with one embodiment.

FIG. 5B is a perspective view of the second electrode of FIG. 5A.

FIG. 5C is a side view of the second electrode of FIG. 5A.

FIG. 5D is a cross-sectional view of the second electrode, taken along line A-A

FIG. 5A.

FIG. 6 is an illustration showing a bottom view of a second electrode having a patterned surface in accordance with one embodiment.

FIG. 7A is an illustration showing a bottom perspective view of a second electrode having a patterned surface in accordance with one embodiment.

FIG. 7B is an illustration showing a bottom perspective view of a second electrode lacking a pattern on its surface in accordance with one embodiment.

FIG. 8 is an illustration showing a cross-sectional view of the second electrode, taken along line A-A FIG. 5A that also depicts a first electrode positioned within the second electrode.

### DETAILED DESCRIPTION

Disclosed herein are electroerosion devices for metal removal by simultaneous electrical discharge machining and pulsed electrochemical machining—(S-ED/PEC). The disclosed electroerosion devices can change from electrical discharge machining (ED) and pulsed electrochemical machining (PEC) modes (and vice versa) through the use of a dual-cathode electrode arrangement in combination with a quasi-dielectric fluid. The disclosed electroerosion devices, taking advantage of both ED and PEC processes, are able to provide improved precision, while lowering the overall cost of machining workpieces. In addition, the quasi-dielectric fluids disclosed herein are renewable resources, thereby decreasing the environmental impact of using the electroerosion devices.

The disclosed electroerosion devices combine electro-thermal discharge with electro-ionic dissolution which can provide S-ED/PEC cutting conditions. The pulsed signal can be divided in two on-time conditions for each ED and PEC process. The pulsed signal can be considered to increase the material removal rate (MRR), which is an important factor for ED processes. One of the characteristics of the disclosed ED/PEC hybrid devices is an increase in material removal efficiency, as indicated by a higher MRR, and a reduction in surface roughness. However, it is known that ED processes that can significantly improve MRR also typically result in providing a heat affect zone (HAZ), which can be detrimental to workpieces. In contrast to these known ED processes, the disclosed ED/PEC processes have been found to significantly increase MRR, while also reducing the HAZ by approximately 10 times at about 2 to 20 μm.

### 1. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, are expressly enumerated in this specification. These are only examples of what is specifically intended, and all possible combinations of numerical values between and including the lowest value and the highest value enumerated are to be considered to be expressly stated in this application.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

### 2. Electroerosion Device

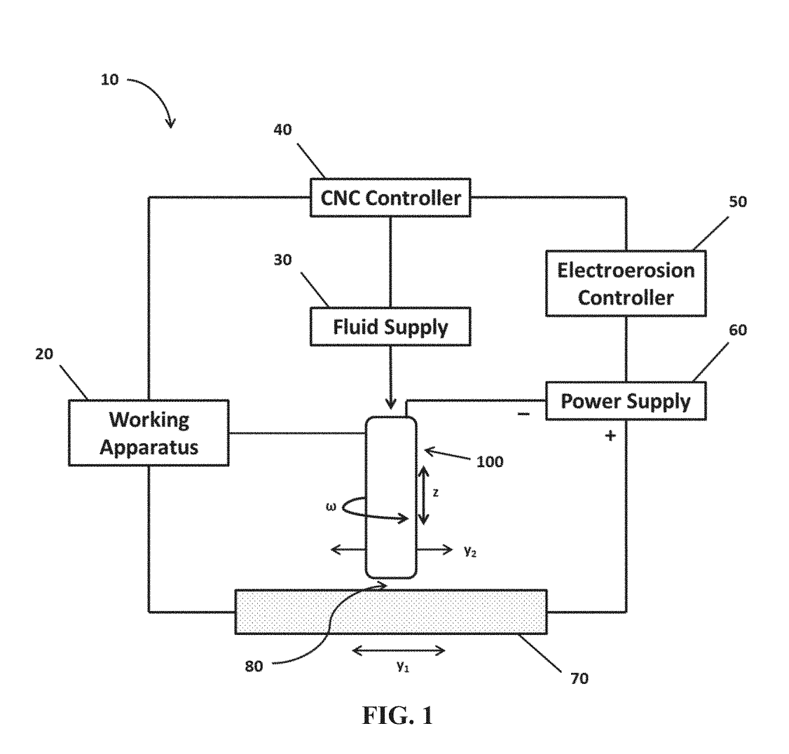

FIG. 1 schematically illustrates an electroerosion device, such as a device 10 for performing ED, PEC, or both, in accordance with some embodiments of the invention. In an embodiment of the invention, the electroerosion device 10 is used to remove material from a workpiece 70 layer by layer to form a desired configuration. The electroerosion device 10 may comprise a working apparatus 20, a numerical control (NC) 40, a power supply 60, a fluid supply 30, an electroerosion controller 50, and an electrode assembly 100.

A. Electrode Assembly

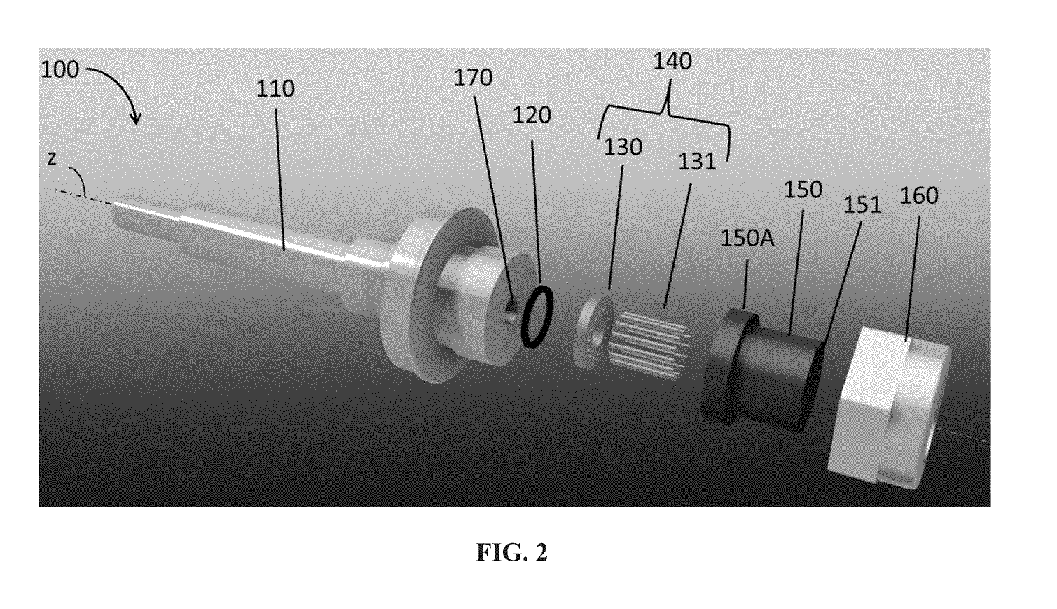

The electrode assembly 100 can be configured to machine any desired configuration in the workpiece 70. FIG. 2 illustrates an exemplary electrode assembly 100 of the electroerosion device 10. The electrode assembly 100 comprises a first electrode 140 and a second electrode 150, where the first electrode 140 may be used for PEC processes, and the second electrode 150 may be used for ED processes. The first electrode 140 includes a conductive metal base 130 and at least one conductive metal pole 131 having a first axial end arranged on the conductive metal base 130 and a second axial end extending from the conductive metal base 130. In some embodiments including the illustrated embodiment, the at least one conductive metal pole 131 is a plurality of conductive metal poles. In some embodiments, the at least one conductive metal pole 131 comprises a set of 4 to 48 conductive metal poles (e.g., 14 poles as illustrated) arranged in a circular pattern on the metal base 130. For example, the center of each pole 131 can be located on a pitch circle diameter centered about a central or “z”-axis of the electrode assembly 100, and the poles 131 can have equal or unequal spacing distances therebetween. In embodiments that include a plurality of conductive metal poles, the poles 131 can be arranged in variable geometric arrangements. In some embodiments, the conductive metal poles 131, at each occurrence, independently have a diameter from about 0.1 mm to about 3 mm. The conductive poles 131 may be solid or tubular.

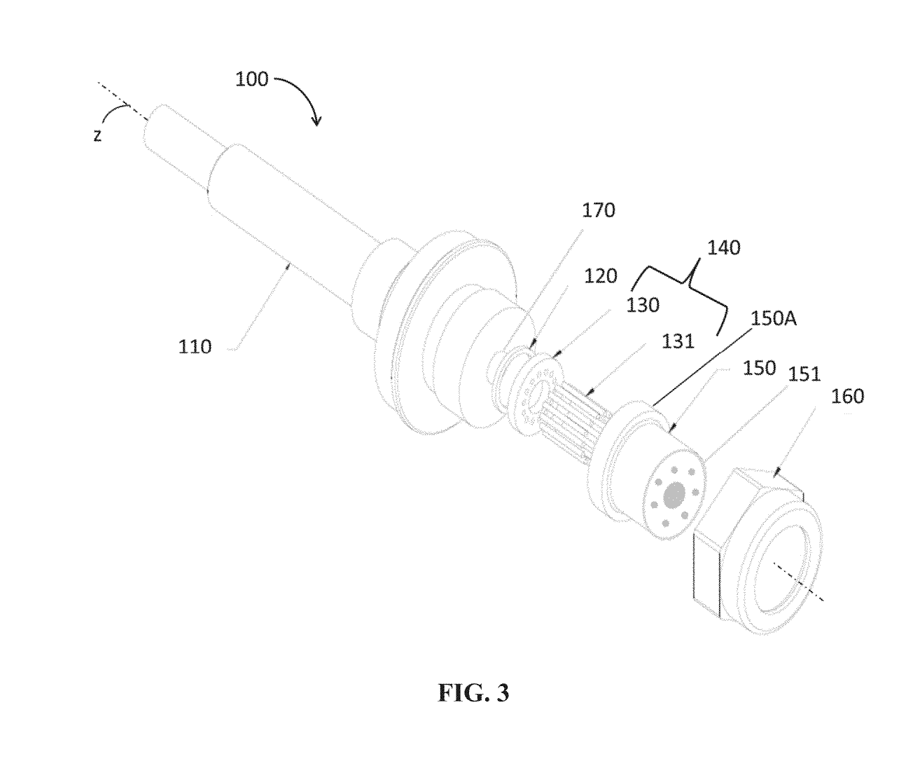

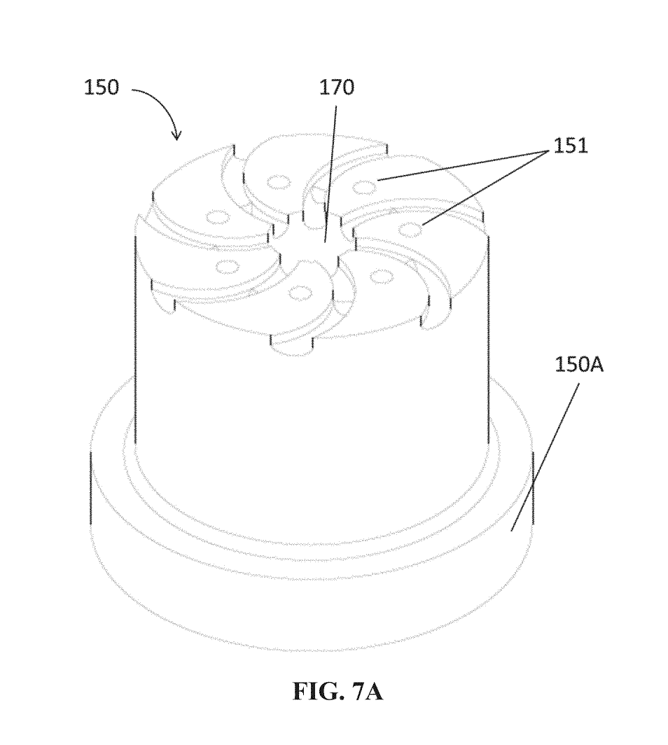

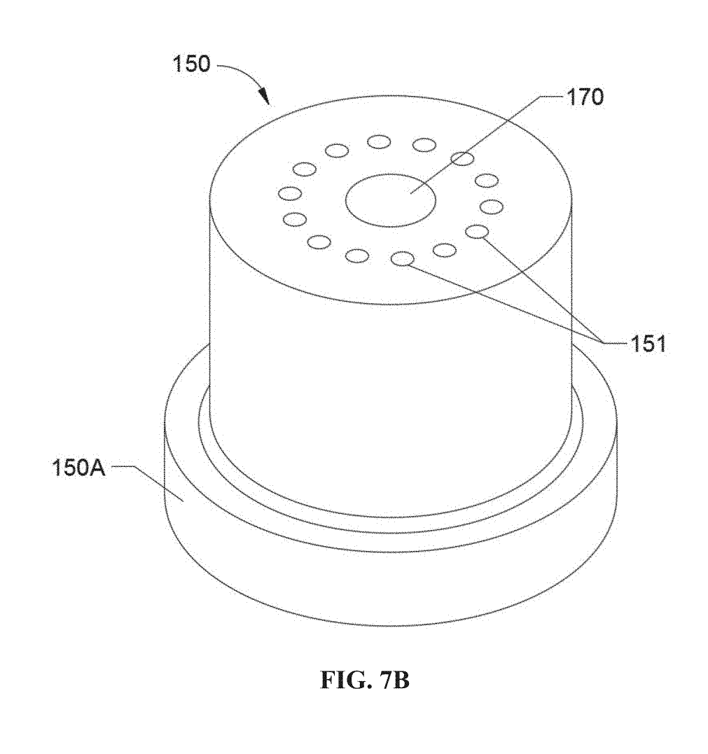

The second electrode 150 may be secured to the electrode assembly 100 by being positioned within an outer metal ring 160. For example, the second electrode 150 includes a lip or shoulder 150A of increased diameter to be retained by the outer metal ring 160 when inserted through (see, e.g., FIGS. 2-4, 7A and 7B).

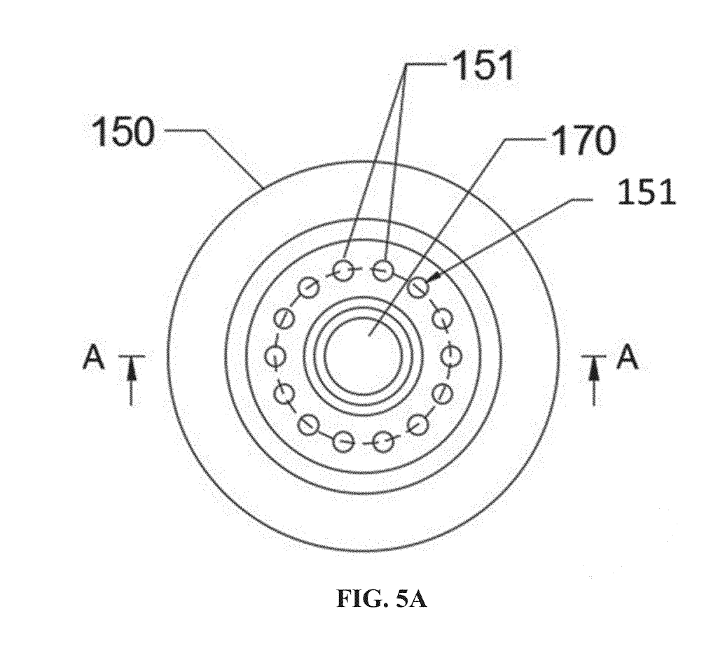

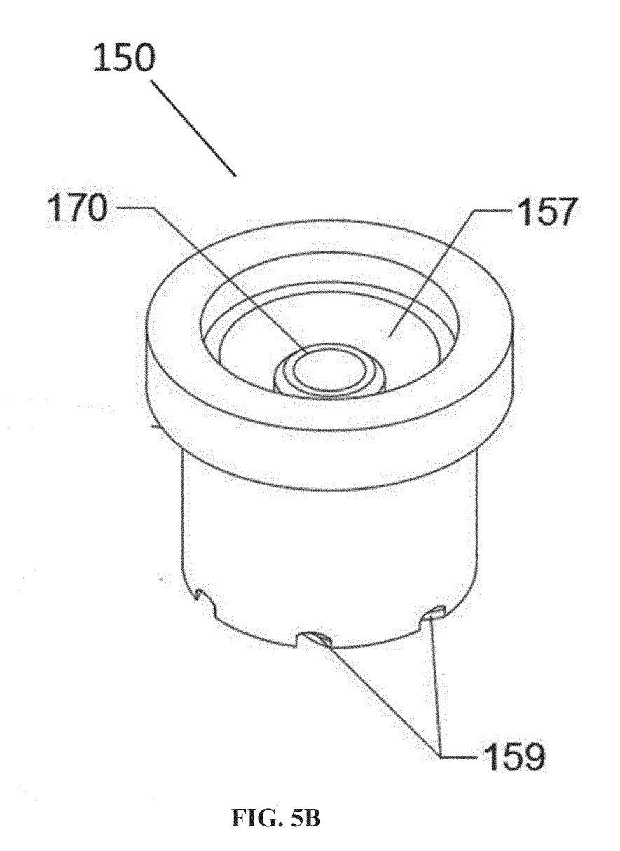

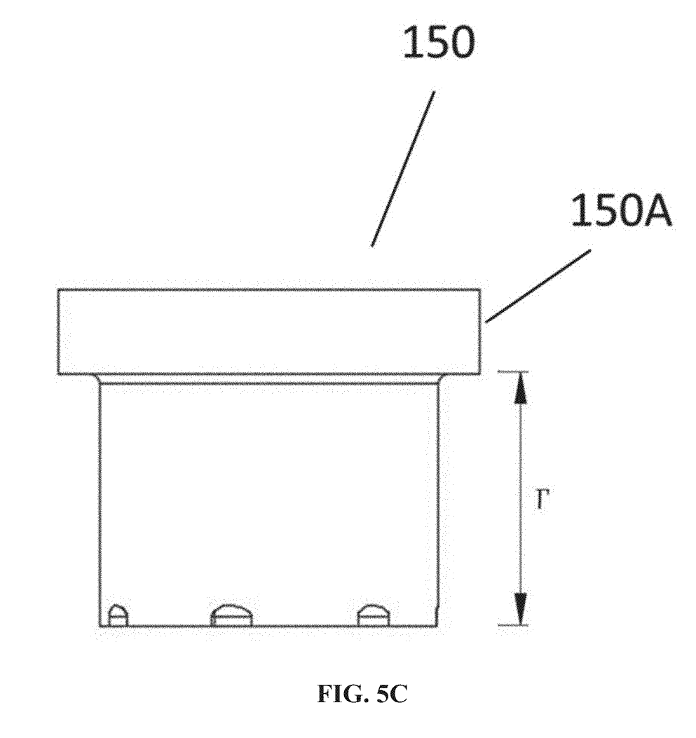

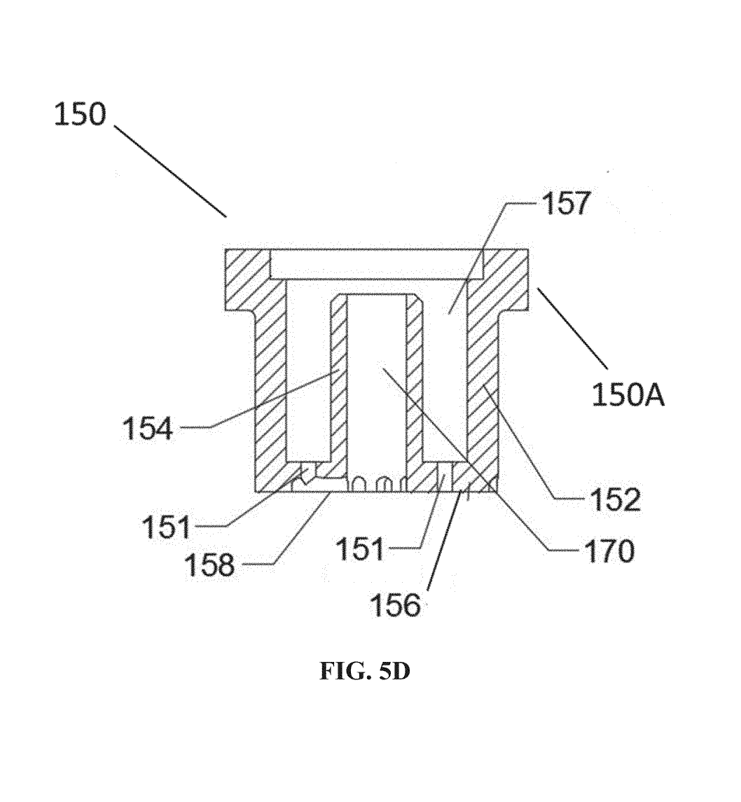

The second electrode 150 can be formed to include multiple cylindrical walls including an outer cylindrical wall 152, an outside of which defines the outer diameter of the second electrode 150 and an inner cylindrical wall 154, an inside of which defines the inner diameter of the second electrode 150 as shown in FIG. 5D. The second electrode 150 is open to receive the first electrode 140 on a first axial end, while an end wall 156 extends between the outer and inner cylindrical walls 152, 154 to at least partially close an opposite second axial end. An annular pocket or trough 157 (or plurality thereof), open to the first axial end to receive the first electrode 140 and having a second axial end proximal to the second axial end of the second electrode 150, is defined between a radial inner surface of the outer cylindrical wall 152 and a radial outer surface of the inner cylindrical wall 154.

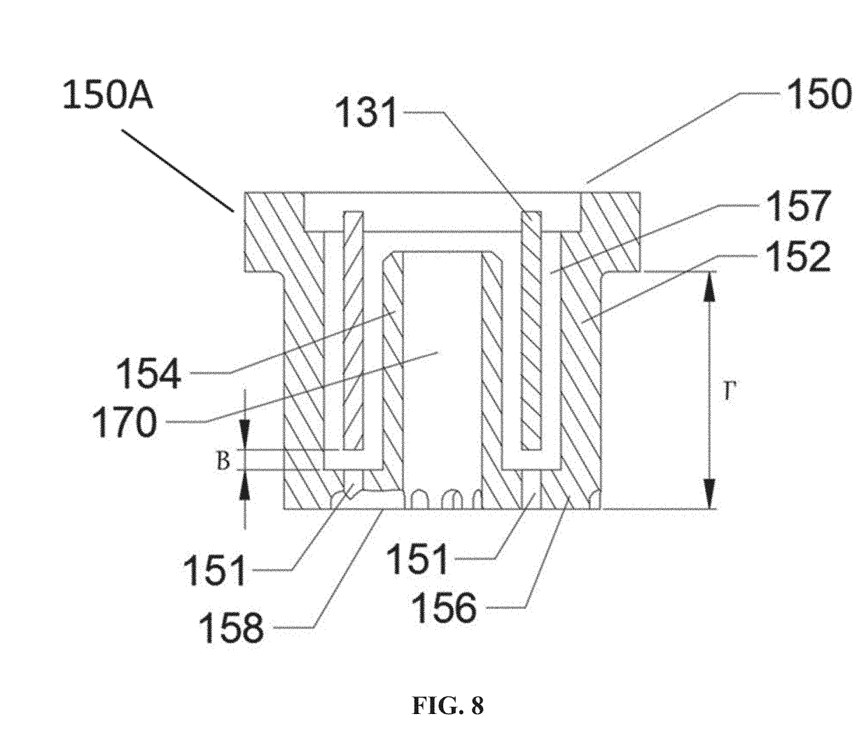

As shown in FIG. 8, the at least one conductive metal pole 131 can be positioned within the annular pocket 157 where there is a gap β between the second axial end of the annular pocket 157 along the z-axis and the second axial end of the metal pole 131 along the z-axis. Accordingly, there may be a gap between the first electrode 140 and the second electrode 150. The gap β between the second axial end of the metal pole 131 and the second axial end of the annular pocket 157 may be about 1 mm to about 3 mm. In an exemplary embodiment, the gap between the second axial end of the metal pole 131 and the second axial end of the annular pocket 157 is about 2 mm.

The second electrode 150 may have a plurality of fluid outlets 151 provided in the end wall 156 and a channel 170 that allow the working fluid to be fed towards the workpiece 70. The channel 170 can be a central channel arranged or centered on the central or “z”-axis. The plurality of fluid outlets 151 may be arranged in variable geometric patterns. In addition, the plurality of fluid outlets 151 may be arranged around the channel 170, where the channel 170 is in a central position. In some embodiments, the plurality of fluid outlets 151 align with the arrangement (e.g., matching pitch circle diameter) of the at least one conductive metal pole 131, which can for example, match the fluid outlets 151 in number. The poles 131 can align with respective fluid outlets 151 or have a predetermined angular offset.

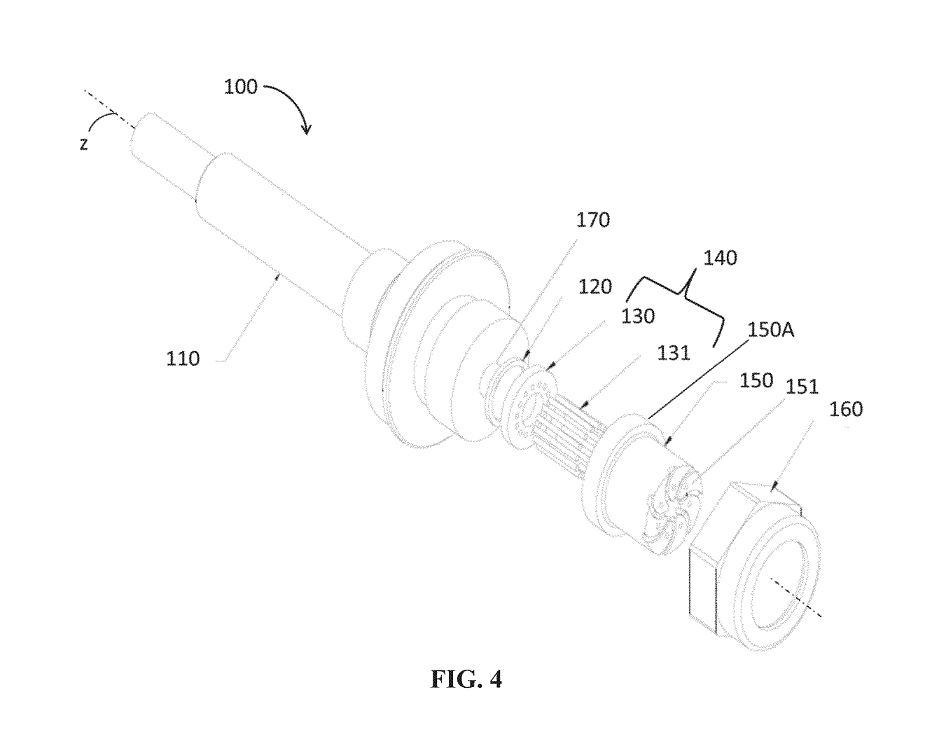

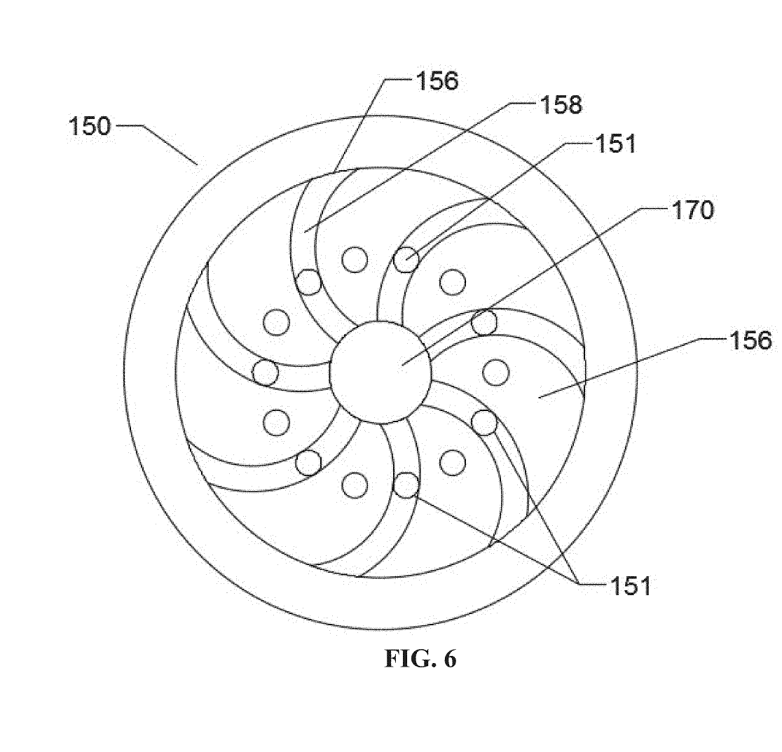

FIGS. 4-7A depict that the second electrode 150 may have a patterned surface. As seen in FIGS. 4-7A the end wall 156 of the second electrode 150 can include one or more fluid pathways 158 on a bottom side thereof (e.g., on the second axial end, opposite the annular trough 157). Each of the fluid pathways 158 can have a spiral shape when viewed along the central “z”-axis. The spiral pathways 158 can extend radially outward to the radial outer extent of the outer cylindrical wall 152 to define respective outlets 159. At a radial inner end, each spiral pathway 158 can open into the central channel 170. Thus, a fluid dispersion pathway is established between the channel 170 and the radial outer edge of the second electrode 150 by each spiral pathway 158. One or more of the spiral pathways 158 can further intersect one or more of the fluid outlets 151 that extend axially through the end wall 156. For example, each one of the spiral pathways 158 can intersect with one of the fluid outlets 151 to establish a fluid dispersion pathway from the fluid outlet 151 to the outlet 159 of the respective spiral pathway 158. The spiral pathways 158 can number less than the fluid outlets 151. For example, the spiral pathways 158 may be half in number of the fluid outlets 151. As such, every other one of the fluid outlets 151, taken in a circumferential direction, may connect with one of the spiral pathways 158, while the remaining fluid outlets 151 extend through the end wall 156 at locations between two adjacent spiral pathways 158. Thus, the fluid outlets 151 that extend between adjacent spiral pathways 158 extend to outlets at a further extent toward the second axial end.

The first electrode 140 and the second electrode 150 are generally manufactured from conductive materials such as graphite, brass, copper, bronze, stainless steel, tungsten or combinations thereof. In an exemplary embodiment, the first electrode 140 is made of bronze. In an exemplary embodiment, the second electrode 150 is made of graphite or tungsten.

The electrode assembly 100 may have a tubular metal piece 110. The electrode assembly 100 may be mounted to the working apparatus 20 through the tubular metal piece 110, and in some embodiments the tubular metal piece 110 may be a rotative mandrel header. The electrode assembly 100 may also include a plastic ring 120 that tightly secures the tubular metal piece 110 to the base 130 of the first electrode 140.

The electrode assembly 100 may be in fluid communication with the fluid supply 30. As seen in FIGS. 2-4, the electrode assembly may have a channel 170 running through it, from the tubular metal piece 110 through the outer metal ring 160. This channel allows fluid to flow through the electrode assembly and be fed towards the workpiece 70.

The first electrode 140 may be arranged in the second electrode 150 with a working fluid (provided by the fluid supply 30) inside the electrode assembly 100. This can allow an electrical conduction through the working fluid (e.g., quasi-dielectric fluid) by the first electrode 140 and workpiece 70 producing an electrochemical reaction of ionic species in low concentrations, which can produce metallic (e.g., Fe) dissolution of the workpiece 70 and by water electrolysis redox reactions. Accordingly (and as discussed above), the first electrode 140 can perform PEC processes and the second electrode 150 can then be used to perform ED processes simultaneously, sequentially, or both on the workpiece 70. In some embodiments, the electrode assembly 100 may be connected with electrical polarity opposite to a pulsed power source 60 to generate an over potential between the electrode-workpiece system arranged in order to perform the aforementioned ED, PEC, or both.

B. Fluid Supply

The electroerosion device 10 uses a fluid supply 30 to provide the working fluid to perform PEC, ED, or both. For example, the fluid supply 30 contains the working fluid and can be configured to feed the working fluid between the electrode assembly 100 and the workpiece 70. The electroerosion device 10 uses a working fluid that is a quasi-dielectric fluid that may comprise deionized water. The quasi-dielectric fluid may include salts at varying concentrations. Examples of salts include, but are not limited to, NaBr, NaCl, KCl, Na₂SO₄ and combinations thereof. In addition, the working fluid may include an acid, such as HCl. The quasi-dielectric fluid is a low resistivity working fluid. Low-resistivity, as used herein, refers to a fluid having a resistivity from about 0.01 MΩ·cm to about 1.5 MΩ·cm. In an exemplary embodiment, the working fluid has a resistivity from about 0.1 MΩ·cm to about 0.75 MΩ·cm. The resistivity of the quasi-dielectric fluid can be adjusted by varying small concentrations of total dissolved solids (TDS) within the fluid. For example, TDS can be added to the quasi-dielectric fluid at a few parts per million. The quasi-dielectric fluid is bi-characteristic in that it can act in a weak electrochemical reaction in PEC processes and simultaneously act as a quasi-dielectric for ED processes.

In some embodiments, the working fluid is fed into the inside of the electrode assembly 100 at high pressure by a pump system, and is ejected through the double electrode configuration to the workpiece 70, while the electrode assembly 100 is rotating.

In some embodiments, the fluid supply 30 is in communication with and receives pre-programmed instructions from the NC 40 for feeding the working fluid between the electrode assembly 100 and the workpiece 70. Alternatively, the fluid supply 30 may be fed separately.

C. Working Apparatus

The electroerosion device 10 includes a working apparatus 20 that is configured to move the electrode assembly 100 relative to the workpiece 70, and which in turn can be controlled by a control system. In some embodiments, the NC 40 device is used to perform conventional automated machining. In some examples, the working apparatus 20 comprises a machine tool or lathe including servomotors (not shown) and spindle motors (not shown), which are known to one skilled in the art. The electrode assembly 100 may be mounted on the working apparatus 20 for performing electroerosion machining. The servomotors may drive the electrode assembly 100 and the workpiece 70 to move opposite to each other at a desired speed and path, and the spindle motors may drive the electrode assembly 100 to rotate at a desired speed. The electroerosion device may perform both milling and drilling processes via electroerosion techniques.

D. Power Supply

The power supply 60 provides electrical power to the electrode assembly 100. In the illustrated embodiment of FIG. 1, the power supply 60 comprises a direct current (DC) pulse generator. The electrode assembly 100 and the workpiece 70 may be connected to negative and positive poles of the power supply 60, respectively. Accordingly, in some embodiments, the electrode assembly 100 functions as a cathode and the workpiece 70 may act as an anode. In other embodiments, the polarities on the electrode assembly 100 and the workpiece 70 are reversed. The power supply 60 may function at a range from about 1 kHz to about 100 kHz. In addition, the power supply 60 may have an open circuit voltage from about 50 VDC to about 80 VDC and about 20 amperes to about 800 amperes.

E. Numerical Controller (NC)

The electroerosion device 10 includes a control system, e.g., the NC 40, for allowing communication between different elements of the electroerosion device 10. The control system 40 may be configured to control the electrical power supplied by the power supply 60, as well as both the rotation and the advance of the electrode assembly 100.

In some embodiments, the NC 40 is a computer numerical controller (CNC). The CNC 40 comprises pre-programmed instructions based on descriptions of the workpiece 70 in a computer-aided design (CAD) and a computer-aided manufacturing (CAM), and may be connected to the working apparatus 20 to control the working apparatus 20 to drive the electrode assembly 100 to move, rotate or both according to certain operational parameters, such as certain feed rates, axes positions, or spindle speeds. In some embodiments, the CNC 40 is a general CNC and comprises central processing units (CPU), read only memories (ROM), random access memories (RAM), or both as known to one skilled in the art.

The CNC 40 may provide multi-axes movements of the electrode assembly 100 (e.g., x, y₂ and z directions, as well as rotation (w)) and workpiece 70 (e.g., y₁ direction) for 3D complex machining. For example, the CNC 40 determines a machining path for the positioning of the electrode assembly 100 on the workpiece 70. The electrode assembly 100 may comprise electromechanical components that are in communication with the CNC 40. The position(s) of the electrode assembly 100 may be controlled by an algorithm that defines the gap distance 80 (from nm to μm) on axis “z”, which can be critical for the removal of material in a controlled manner via PEC, ED, or both. In addition, the algorithm may control the movement of the electrode assembly 100 along the surface contour of the workpiece 70 with movements on axes “x, y” according to a machining sequence. The algorithm can control the adjustment of penetration position of the “z”-axis to maintain the S-PEC/ED processes. The electroerosion device 10 may be operated by the algorithm having pulsed electrical signals in voltage and current relationship that are fed into the algorithm, such as fuzzy logical, neural network or heuristic rules. The control algorithm may allow self-adjustment of the gap distance 80 in “z”-axis between the electrode assembly 100 and workpiece 70, as well as electrical parameters of the discharge condition and electro-dissolution conditions for improved removal of material.

F. Electroerosion Controller

The electroerosion device 10 may include an electroerosion controller 50 connected to the power supply 60 to monitor the status of the power supply 60. In some embodiments, the electroerosion controller 50 comprises one or more sensors (not shown), such as a voltage and/or current measurement circuit for monitoring the status of voltages and/or currents in the gap 80 between the electrode assembly 100 and the workpiece 70. In other embodiments, the sensor(s) is comprised in the power supply 60. In yet other embodiments, the sensor(s) is not comprised in the electrode assembly 100 or power supply 60, but rather are separate individual units relative to the electrode assembly 100 and power supply 60. In some embodiments, the electroerosion controller 50 comprises a microprocessor or another computational device, a timing device, a voltage comparison device, and/or a data storage device to be served as the sensor(s), as known to one skilled in the art. Additionally, the electroerosion controller 50 may communicate with the NC 40 to control the power supply 60 and the movement of the working apparatus 20 holding the electrode assembly 100.

### 3. Methods of Using the Electroerosion Devices

Also disclosed herein are methods of performing electroerosion machining methods using the electroerosion device 10 as described above. The methods may include the first electrode 140 performing PEC processes and the second electrode 150 preforming ED processes using the same electrical pole via open circuit voltage under direct-current (DC) supplied by a power supply 60 capable of providing puled electrical power. This may allow removal of the material from the workpiece 70 in two simultaneous ways using a fluid medium, e.g., quasi-dielectric working fluid. In PEC processes, the quasi-dielectric working fluid is circulated between the first electrode 140 and the workpiece 70, permitting electrochemical dissolution of the workpiece 70 material, as well as cooling and flushing the gap region 80 therebetween. In ED processes, the quasi-dielectric working fluid is circulated between the second electrode 150 and the workpiece 70 to permit electrical discharges in the gap 80 therebetween for removing the workpiece 70 material. This operation of S-PEC/ED processing may increase the material removal rate with minimum (or without) formation of a recasting molten layer or white-layer when, e.g., drilling holes in a high strength steel (HSS) or other materials having high hardness.

The second electrode 150 has a depth length F (see, e.g., FIGS. 5C and 8) that can be greater than the thickness of the workpiece 70 being machined. For example, the second electrode 150 may have a depth length F from about 5 mm to about 25 mm. The depth length F may be measured as the axial length of the second electrode 150, less the portion forming the lip or shoulder 150A, which is not exposed for operation, but rather retained within the outer metal ring 160. In addition, the second electrode 150 may have a separation distance from the workpiece 70 when performing ED processes from about 10 μm to about 100 μm, such as from about 20 μm to about 90 μm or from about 30 μm to about 80 μm. In an exemplary embodiment, the second electrode 150 has a separation distance from the workpiece 70 when performing ED processes of about 60 μm. The combination of depth length F of the second electrode 150, the separation distance of the second electrode 150 from the workpiece 70, and the gap β between the first electrode 140 and the second electrode 150 are all useful parameters for performing the disclosed electroerosion machining methods.

In some embodiments, the electroerosion device 10 may provide a diameter of drilling having a range from about ¼ inch to about 3 inches. The diameter of drilling can be in part a function of the dimensions of the first electrode 140 and the second electrode 150. Accordingly, by altering the dimensions and arrangement of the first electrode 140 and the second electrode 150, the diameter of drilling for the electroerosion device 10 may be altered.

What is claimed is:

1. An electroerosion device comprising:
an electrode assembly defining a central axis, the electrode assembly comprising a first electrode and a second electrode, the second electrode having a first open axial end to receive the first electrode and a second axial end that is at least partially closed by an end wall;
a fluid supply containing a working fluid having a resistivity from about 0.01 MΩ·cm to about 1.5 MΩ·cm;
a working apparatus configured to translate the electrode assembly relative to the workpiece;
a power supply for electrically powering the electrode assembly; and
a control system configured to control the power supply and the working apparatus.

2. The electroerosion device of claim 1, wherein the first electrode comprises a conductive metal base and at least one conductive metal pole arranged on the base.

3. The electroerosion device of claim 2, wherein the second electrode comprises an annular pocket open to the first axial end of the second electrode to receive the at least one conductive metal pole of the first electrode, and having a second axial end proximal to the second axial end of the second electrode.

4. The electroerosion device of claim 3, wherein the at least one conductive metal pole has a first axial end and a second axial end, and wherein a gap from about 1 mm to about 3 mm is present between the second axial end of the at least one conductive metal pole and the second axial end of the annular pocket.

5. The electroerosion device of claim 2, wherein the at least one conductive metal pole comprises a set of 4 to 48 conductive metal poles arranged in a circular pattern on the metal base.

6. The electroerosion device of claim 5, wherein the second electrode comprises a plurality of fluid outlets in the end wall of the second axial end of the second electrode that align in number and arrangement with the set of conductive metal poles.

7. The electroerosion device of claim 6, wherein the second electrode comprises a channel centered on the central axis of the electrode assembly, and wherein the plurality of fluid outlets are arranged around the channel in a central position.

8. The electroerosion device of claim 7, wherein the second electrode has one or more fluid pathways on the second axial end of the second electrode.

9. The electroerosion device of claim 8, wherein the one or more fluid pathways are spiral shaped and extend radially outward from the channel of the second electrode.

10. The electroerosion device of claim 1, wherein the electrode assembly further comprises a tubular metal piece configured to be mounted on the working apparatus.

11. The electroerosion device of claim 1, wherein the electrode assembly is configured to feed the working fluid through a channel running through the center of the electrode assembly.

12. The electroerosion device of claim 1, wherein the working fluid comprises deionized water and a salt selected from the group consisting of NaBr, NaCl, KCl, Na₂SO₄ and combinations thereof.

13. The electroerosion device of claim 1, wherein the first electrode comprises stainless steel, tungsten, graphite, brass, bronze, copper, or a combination thereof.

14. The electroerosion device of claim 1, wherein the second electrode comprises stainless steel, tungsten, brass, bronze, copper, graphite or a combination thereof.

15. The electroerosion device of claim 1, wherein the power supply causes the first electrode, the second electrode or both to have a positive polarity and the workpiece to have a negative polarity.

16. An electroerosion machining method, the method comprising:
driving an electrode assembly towards a workpiece, wherein the electrode assembly comprises a first electrode and a second electrode, the second electrode having a first open axial end to receive the first electrode and a second axial end that is at least partially closed by an end wall;
supplying an electrical current between the electrode assembly and the workpiece while feeding a working fluid from a fluid supply through a gap defined therebetween, wherein the working fluid has a resistivity from about 0.01 MΩ·cm to about 1.5 MΩ·cm and comprises NaBr, NaCl, KCl, Na₂SO₄, HCl or combinations thereof; and
performing electrical discharge machining (ED), pulsed electrochemical machining (PEC), or a combination thereof.

17. The method of claim 16, wherein the first electrode comprises a conductive metal base and at least one conductive metal pole arranged on the base.

18. The method of claim 17, wherein the second electrode comprises an annular pocket open to the first axial end of the second electrode to receive the at least one conductive metal pole of the first electrode, and having a second axial end proximal to the second axial end of the second electrode.

19. The method of claim 16, wherein the second electrode has a depth length from about 1 mm to about 20 mm.

20. The method of claim 16, wherein the second electrode has a separation distance from the workpiece from about 10 μm to about 100 μm when performing ED processes.
